(19) United States
(12) Patent Application Publication
(10) Pub. No.: US 2022/0009008 A1
(43) Pub. Date: Jan. 13, 2022

(54) Insert Tool

(71) Applicant: Robert Bosch GmbH, Stuttgart (DE)

(72) Inventor: Massimo Anghileri, Solothurn (CH)

(21) Appl. No.: 17/370,631

(22) Filed: Jul. 8, 2021

(30) Foreign Application Priority Data
Jul. 9, 2020 (DE) 10 2020 208 607.9

(51) Int. Cl. B23B 51/02

(52) U.S. Cl. CPC B23B 51/02

(57) ABSTRACT

An insert tool, in particular a drilling tool, having a base module is disclosed. The base module has a first portion, which in particular includes a conveying helix, and a second portion, which includes cutting bodies with preferably at least two rake faces. The second portion is connected to a first end of the first portion in an integrally bonded manner. The base module is connected, at a second end, to an, in particular hardened, insertion end in an integrally bonded manner by way of in particular a friction welding method.

This application claims priority under 35 U.S.C. § 119 to patent application no. DE 10 2020 208 607.9, filed on Jul. 9, 2020 in Germany, the disclosure of which is incorporated herein by reference in its entirety.

### BACKGROUND

The process of manufacturing drilling tools is complex. Starting from a blank, what happens first of all is that the shaft is adapted to the tool receptacle of the handheld power tools provided. Furthermore, a conveying helix is produced, the drilling head has to be connected and/or ground, and possibly the drilling tool is also colored. As a result, the process for manufacturing drilling tools is very cost-intensive.

### SUMMARY

The disclosure relates to an insert tool, in particular a drilling tool, having a base module, the base module having a first portion, which in particular comprises a conveying helix, and a second portion, which comprises a cutting body with preferably at least two rake faces, the second portion being connected to a first end of the first portion in an integrally bonded manner. It is proposed that the base module is connected, at a second end, to an, in particular hardened, insertion end in an integrally bonded manner by means of, in particular, a friction welding method. This advantageously makes it possible to reduce the complexity of the manufacturing process. The base module is produced in a first step, and in a second step, the insert tool is individualized by means of the insertion end, a cutting body design and a coloring.

The drilling tool particularly takes the form of a rock drill bit which is provided for a hammer drill. Alternatively, it is also conceivable for the drilling tool to take the form of a metal drill bit, wood drill bit or a tile drill bit.

The first portion has, in particular, a basic body. The first portion is preferably formed in one piece or integrally, with the result that the first portion is formed by the basic body. In the context of this application, the term “integral” is to be understood in particular as meaning an individual structural part which does not have any type of connection to other structural parts, for example by means of an integrally bonded connection. An integral structural part consists of one material. In the context of this application, the term “in one piece” is to be understood as meaning in particular also structural parts which have a plurality of components which are connected to one another in an integrally bonded manner. A one-piece structural part can consist of one or more materials.

The first portion, in particular the basic body, is preferably formed from a high-speed steel or from a steel suitable for hardening, such as, for example, 42CrMo4, 46CrB2, 41Cr, 34CrNiMo16 or C45, C50. The basic body preferably has a hardness in the range between 48 and 56 HRC (Hardness Rockwell C). The conveying helix can be designed in such a way that it extends rectilinearly or spirally around a longitudinal axis of the drilling tool. Here, the conveying helix has at least one groove. It is also conceivable for the conveying helix to have a plurality of grooves, for example two, three or four grooves, the grooves preferably extending along or around the longitudinal axis of the drilling tool while being uniformly spaced apart from one another. Alternatively, it is also conceivable for the first portion not to have a conveying helix.

The second portion is particularly formed in one piece, with the result that the second portion is formed by the cutting body. The cutting body has a tip by means of which the insert tool or the drilling tool is placed or applied during use to the workpiece to be machined. The tip can take the form, for example, of a chisel edge. The cutting body is formed in particular from a hard metal. Alternatively, it would also be conceivable for the first portion and the second portion or the basic body and the cutting body to be formed integrally. In particular, the second portion has a higher hardness than the first portion. Preferably, the cutting body has a higher hardness than the basic body. The cutting body preferably has two cutting edges. The first and the second cutting edge are preferably designed as main cutting edges. In particular, the cutting edges each form a transition between a rake face and a flank. The two cutting edges are particularly arranged on different sides of the cutting body, the sides being separated by a plane along the center axis of the cutting body. The cutting edges extend substantially rectilinearly at least in certain portions. The wedge angle of the first and/or of the second cutting edge lies in particular in a range from 60° and 120°, preferably in a range between 80° and 100°. Preferably, the wedge angle is substantially 90°. Preferably the wedge angle of the first cutting edge and the second cutting edge is identical substantially at least in certain portions, preferably completely identical. The starting point of the cutting edge is situated in particular in the region of the tip. Preferably, the starting point at least partially forms the tip of the cutting body. The end point of the first cutting edge and/or the second cutting edge is preferably arranged on a radially outer edge of the cutting body.

The insertion end is formed in particular in one piece or integrally. The insertion end is preferably formed from a steel. In particular, the insertion end is formed from the same material as the basic body. The insertion end is hardened prior to the connection with the base module. The hardening process necessary for this purpose is carried out in particular by means of a furnace and is already known. The insertion end and the basic body are thus formed in one piece, but not integrally, with one another after the connection process. Advantageously, the insertion end can as a result be hardened in the furnace without the basic body, as a result of which a larger number of insertion ends can be hardened for each hardening process. The insertion end is designed for coupling to a handheld power tool, such as, for example, a hammer drill or percussion hammer. Preferably, the drilling tool is formed in the region of the insertion end in such a way that the drilling tool is able to be coupled to a tool receptacle of the handheld power tool. By way of example, the insertion end can have form-fitting elements in the form of special grooves which form an SDS-plus interface or an SDS-max interface. The insertion end can also take the form of a cylinder shaft, in particular a round shaft or a cylinder shaft with bevel, preferably three bevels. Alternatively, the insertion end can also take the form of an outer-edge shaft, in particular a 4-edge shaft or a 6-edge shaft or Hex shaft. In order to machine a workpiece, the drilling tool is set by means of the hammer drill into a rotating and linearly oscillating or percussive state. During the machining, the drilling tool penetrates into the workpiece in the advancing direction. The advancing direction of the drilling tool runs coaxially to the longitudinal axis or axis of rotation and, starting from the insertion end, in the direction of the cutting body. The longitudinal axis of the drilling tool corresponds in particular to a working axis or axis of rotation of the drilling tool.

What is to be understood as a friction welding method is in particular a method in which two structural parts are moved relative to one another under pressure, with the contact faces contacting one another. The friction-induced heating leads to plasticization of the material and to the connection of the structural parts.

The insert tool can take the form, for example, of a rock drill bit, with a hardness of the cutting body being greater than a hardness of the insertion end, the hardness of the insertion end being greater than a hardness of the basic body.

Alternatively, the insert tool can also take the form, for example, of a metal drilling tool, with a hardness of the cutting body substantially corresponding to the hardness of the insertion end, the hardness of the cutting body being greater than a hardness of the basic body.

Advantageously, on the basis of the same base module, a rock drill bit, a metal drill bit, a tile drill bit, a wood drill bit, etc., can be manufactured.

Furthermore, it is proposed that the cutting body consists at least partially, in particular completely, of hard metal. In particular, the cutting body consists of tungsten carbide.

Furthermore, it is proposed that the cutting body is machined by means of a grinding method in such a way that the cutting body has at least two ground faces, with at least two ground faces taking the form of rake faces. Advantageously, the removing capacity of the insert tools can be increased as a result. In particular, at least one ground face takes the form of a flank. Preferably, the cutting body has at least 4 or at least 7 ground faces. The ground faces can, by way of example, be produced manually or automatically by means of a machine.

Moreover, the disclosure relates to a system consisting of at least a first insert tool and a second insert tool as described above, the base modules of the insert tools being designed to be substantially identical. It is proposed that the base modules of the insert tools are connected to different insertion ends in an integrally bonded manner and/or the cutting bodies are machined by means of different grinding methods. Advantageously, on the basis of the base module, different drilling tools can be provided as a result.

Furthermore, it is proposed that the insert tools have different surface identifiers. Advantageously, additional information can be provided to a user as a result. The surface identifier is designed in particular to provide information with regard to the type, the wear state, the length and/or the width of the insert tool. The surface identifier can take the form, for example, of at least one color which is applied to the insert tool, in particular in the region of the conveying helix. With increasing wear, the color is removed and the user can thus determine the wear state by way of the color. It would also be conceivable for the surface identifier to have a plurality of colors which alternate along the axial extent of the insert tool and are designed to indicate a drill-hole depth. For example, the first two cm starting from the tip can be colored blue, the next two cm colored red and the following two cm colored green. In this way, a user directly viewing the drilling tool has an indication of the present drill-hole depth during the drilling operation. The surface identifier can also take the form of a code, in particular a barcode. The code is intended to provide an unambiguous identification. The code can be read, for example, from the handheld power tool, from an accessory for the handheld power tool or from an external device, such as, for example, a smartphone. Advantageously, the handheld power tool can thus for example be set with an operating parameter range allowed for the insert tool or with an optimum operating parameter.

The surface identifier can be produced, for example, by means of an ink printing method. Here, the surface identifier can be applied in the region of the first portion, in particular in front of or on the conveying helix, in the region of the second portion or in the region of the insertion end.

The printing preferably occurs in an automated manner via a machine in which the insert tools are clamped via the insertion end. In order to make precise printing possible, the printing occurs with the aid of a raster image processor (RIP for short). In order to accelerate drying, the insert tools are dried by means of a UV lamp after the printing operation. Preferably, it is possible by means of the ink printing method for just the conveying helix alone to be printed, without ink being placed on the cutting body. Advantageously, it is possible thereby to dispense with grinding the cutting body after the ink printing method.

Furthermore, the disclosure relates to a method for manufacturing an insert tool in which, in a first method stage, a base module, which has a basic body, which in particular comprises a conveying helix, and a cutting body, is provided, and in a second method stage, by means of in each case at least one method step, the basic body is adapted to a handheld power tool, to a workpiece to be machined, and with a surface identifier. Here, the adaption of the basic body to the handheld power tool occurs via the selection of the insertion end suitable for the handheld power tool. Here, the adaption to the workpiece to be machined occurs through the choice of whether the cutting body is ground and, if yes, how many ground faces this requires. In addition or alternatively, the adaption to the workpiece to be machined can also occur by means of a coating of the cutting body. It is conceivable for example for the cutting body to be provided with a coating which has a greater hardness than the cutting body, thereby improving the wear resistance.

Moreover, it is proposed that a dataset, which information for adapting the base module to a handheld power tool, to a workpiece to be machined, and of the surface identifier, is provided by a computing unit or is provided to a computing unit. Advantageously, automatic production of individualized insert tools can be provided as a result.

### BRIEF DESCRIPTION OF THE DRAWINGS

Further advantages will result from the following description of the drawings. The drawings, the description and the claims contain numerous features in combination. A person skilled in the art will expediently also consider the features individually and combine them to form useful further combinations. Reference signs of features of different embodiments of the disclosure which substantially correspond are provided with the same number and with a letter designating the embodiment.

In the drawings:

FIG. 1 shows a side view of a base module for an insert tool according to the disclosure;

FIGS. 2a-d show side views of various embodiments of insertion ends for the insert tool according to the disclosure;

FIGS. 3a-c show perspective views of various embodiments of ground cutting bodies of the cutting body according to the disclosure;

FIG. 4 shows a flow diagram of a manufacturing method for the insert tool;

FIG. 5 shows a side view of an insert tool according to the disclosure.

### DETAILED DESCRIPTION

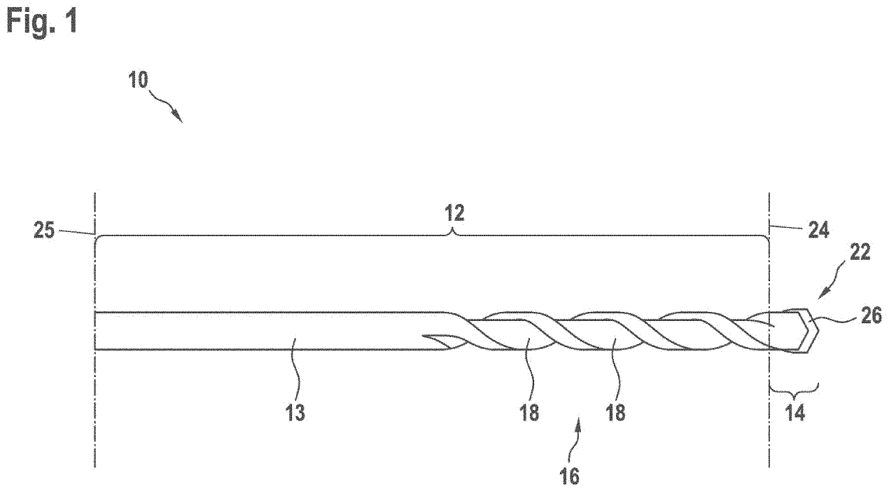

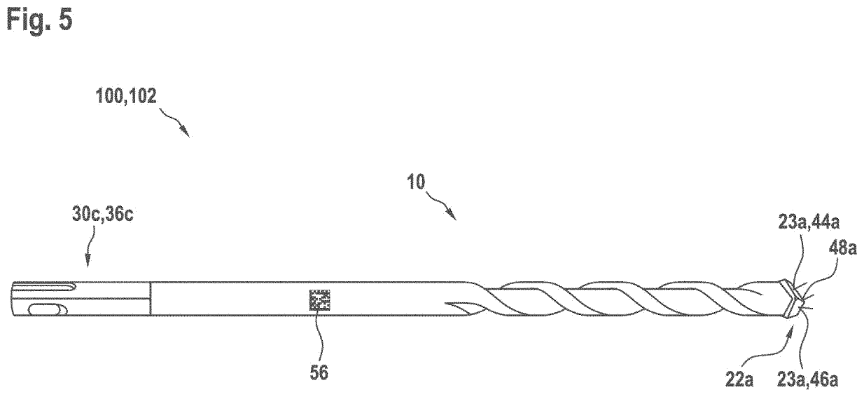

In FIG. 1 there is shown a side view of a base module 10. The base module 10 is provided for an insert tool 100 which takes the form, by way of example, of a rock drill bit 102 (see FIG. 5). The base module 10 has a first portion 12 and a second portion 14.

The first portion 12 comprises a basic body 13 and is designed, by way of example, to be integral. The first portion 12 consists, by way of example, of steel. The first portion 12 has a conveying helix 16 which, by way of example, is of 2-flight design. The conveying helix 16 thus has two grooves 18 which extend spirally around the longitudinal axis 20 of the base module 10. The conveying helix 16 extends by way of example along approx. 50% of the length of the base module 10 and, starting from the center, up to the beginning of the second portion 14. The region of the basic body 13 that faces away from the second portion 14 has a cylindrical lateral surface without grooves.

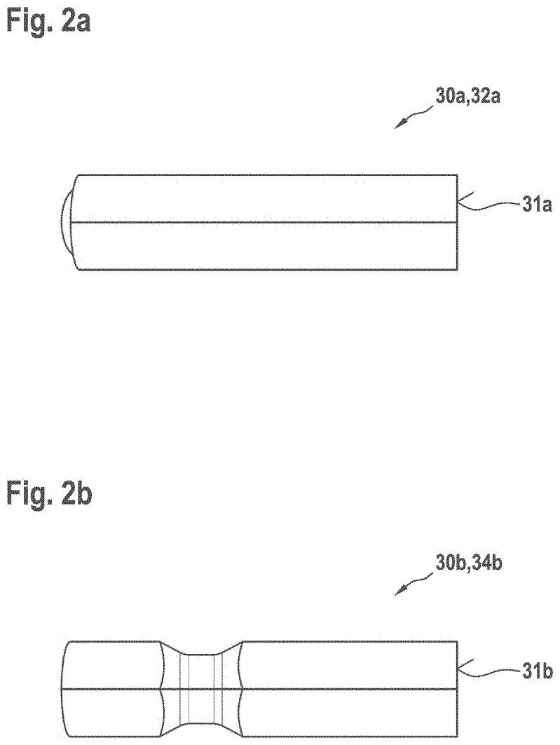

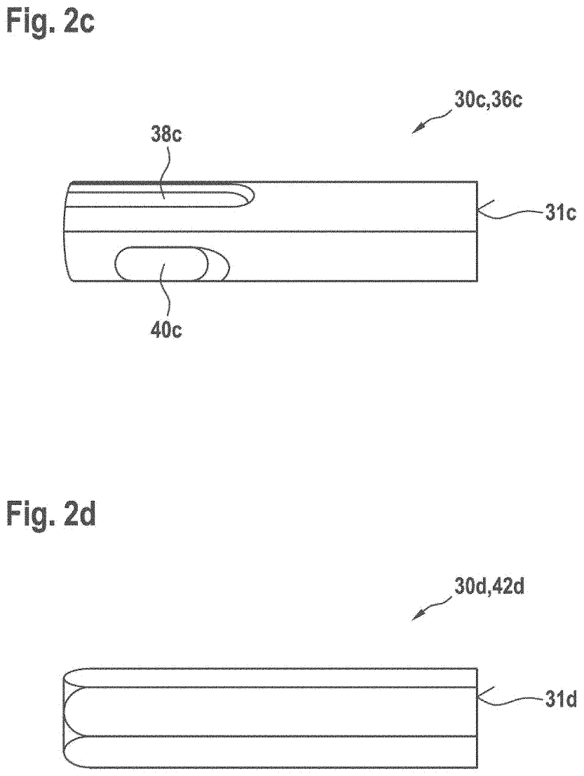

The second portion 14 comprises a cutting body 22 which consists, by way of example, of a hard metal. The cutting body thus has a greater hardness than the basic body 13. The cutting body 22 consists, by way of example, of tungsten carbide. Alternatively, other hard metals would also be conceivable. The cutting body 22 is connected, at a first end 24 of the first portion 12, to the latter in an integrally bonded manner. In the region of the first end 24, the basic body 13 has a cutout in which the cutting body 22 formed as small hard metal plates 26 is inserted and soldered or welded. Alternatively, it would also be conceivable for the cutting body 22 to take the form of a solid hard metal head. In this case, the basic body 13 does not have a cutout, but only a planar joining face which is provided for integrally bonded connection. The second end 25 of the first portion 12 or of the basic body 13 is arranged on a side facing away from the cutting body 22. The second end 25 is provided for connecting the base module 10 to an insertion end 30 in an integrally bonded manner (see FIGS. 2a-d).

In order to achieve a high degree of durability when removing rock, it is very advantageous to form the cutting body 22 from hard metal. If the base module 10 is provided for an insert tool 100 which takes the form of a metal drill bit, it would also be conceivable for the basic body and the cutting body to be formed integrally and thus to be formed from the same material.

In FIG. 2a to FIG. 2d there are shown, by way of example, various insertion ends 30a-30d which, in order to produce the insert tool 100, are connected to the base module 10 by means of a friction welding method. For connection to the base module 10, the insertion ends 30a-30d each have a planar joining face 31a-31d which extends substantially perpendicularly to the longitudinal axis 20 of the base module 10 or of the insert tool 100.

In FIG. 2a there is shown a side view of an insertion end 30a which takes the form of a cylindrical shaft 32a. Handheld power tools taking the form of drilling machines frequently have tool receptacles providing a fit therefor.

In FIG. 2b there is shown a side view of an insertion end 30b which takes the form of a ¾″-hexagon shaft 34b. Handheld power tools taking the form of battery-operated screwdrivers frequently have the tool receptacle providing a fit therefor.

In FIG. 2c there is shown a side view of an insertion end 30c which takes the form of an SDS-plus shaft 36c. The SDS-plus shaft 36c has two opposite open grooves 38c which are arranged on a side of the insertion end 30c that faces away from the joining face 31c. Moreover, the SDS-plus shaft 36c has two closed grooves 40c which are arranged in the circumferential direction between the open grooves 38c. Handheld power tools taking the form of hammer drills frequently have the tool receptacle providing a fit therefor.

In FIG. 2d there is shown a side view of an insertion end 30d which takes the form of a hexagon shaft 42d. Handheld power tools taking the form of heavy demolition hammers frequently have the tool receptacle providing a fit therefor.

By way of cost-effective alternative, it is also conceivable to dispense with a grinding operation and to leave the cutting body 22 as shown in FIG. 1.

Alternatively, further insertion ends which are provided for tool receptacles for handheld power tools are also conceivable.

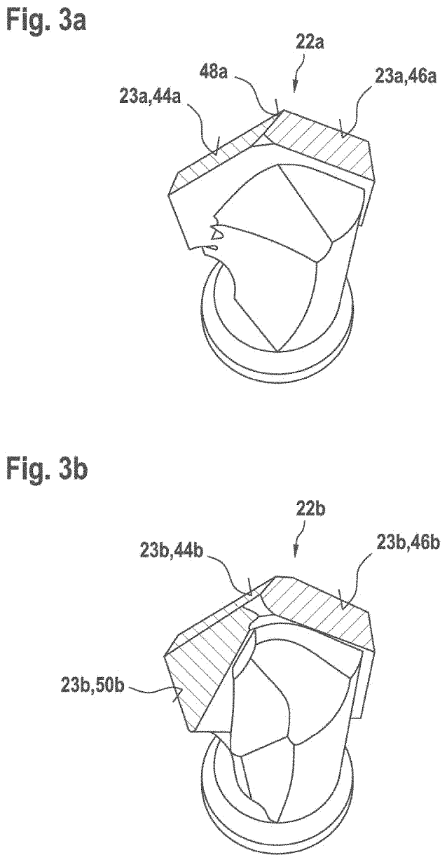

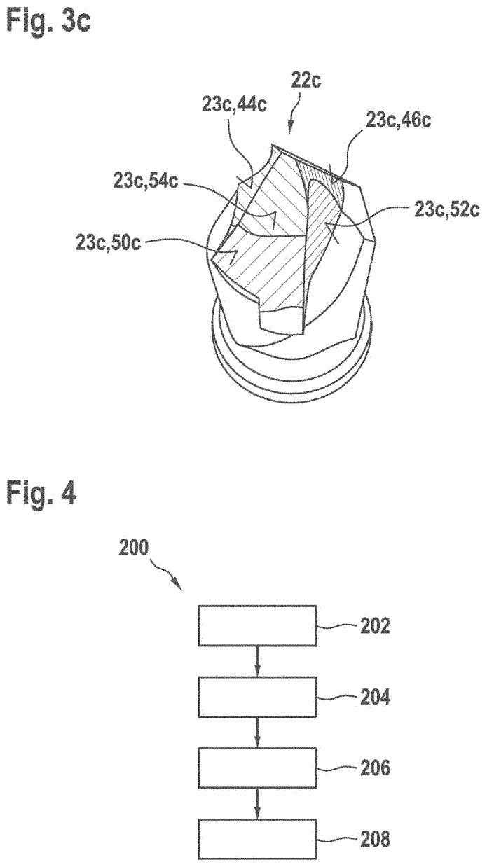

In FIG. 3a to FIG. 3c there are in each case shown cutting bodies 22 of the base module 10 which have been ground by means of a grinding method.

The cutting body 22a in FIG. 3a has, by way of example, two ground faces 23a, namely a first ground face 44a and a second ground face 46a. Here, the two ground faces 44a, 46a extend starting from a chisel edge 48a of the cutting body 22a. The two ground faces 23a can, by way of example, be ground by hand or automatically by means of a machine.

The cutting body 22b has, by way of example, four ground faces 23b. In the perspective view according to FIG. 3b, of the four ground faces 23b only the first, the second and a third ground face 44b, 46b, 50b are shown.

The cutting body 22c has, by way of example, seven ground faces 23c. In the perspective view according to FIG. 3c, of the seven ground faces 23c only the first, the second, the third, the fourth and the fifth ground face 46c, 48c, 50c, 52c and 54c are shown.

In FIG. 4 there is shown a flow diagram 200 for manufacturing the insert tool 100 according to the disclosure.

In a first method stage 202, a base module 10, which has a basic body 13, which comprises a conveying helix 16, and a cutting body 22, is provided. In a second method stage, by means of in each case a method step, the base module 10 is adapted 204 to a handheld power tool, the base module 10 is adapted 206 to a workpiece to be machined, and the base module 10 is adapted 208 with a surface identifier. The illustrated sequence of the method steps 204, 206, 208 of the second method stage is particularly advantageous. However, it would also be conceivable for the method steps to proceed in a different sequence or for method steps to be omitted or added.

In FIG. 5, by way of example, a base module 10 has been adapted with the method steps according to FIG. 4. The base module 10 is connected to the insertion end 30c in an integrally bonded manner by means of a friction welding method and thus provided for handheld power tools taking the form of hammer drills. The cutting body 22a consisting of hard metal is ground by means of a grinding method and has two ground faces 23a. Already with the four insertion ends shown in FIGS. 3a-d and with the three grinding variations shown in FIGS. 3a-c plus the unground cutting body, there result 16 different insert tools that are able to be produced on the basis of the base module. In particular, not only rock drill bits and metal drill bits but also tile drill bits are able to be produced on the basis of the base module. The insert tool 100 has a surface identifier 56 which takes the form, by way of example, of a 3D code. The surface identifier 56 has been applied by means of an RIP ink printing method as the last step of the manufacturing method.

What is claimed is:

1. An insert tool, comprising:
a base module having (i) a first portion which comprises a conveying helix, and (ii) a second portion which comprises a cutting body, the second portion being connected to a first end of the first portion in an integrally bonded manner; and
an insertion end,
wherein the base module is connected at a second end of the first portion to the insertion end in an integrally bonded manner.

2. The insert tool according to claim 1, wherein the insertion end takes the form of a cylinder shaft of an outer-edge shaft and/or of an SDS insertion end.

3. The insert tool according to claim 1, wherein the cutting body comprises, at least partially, a hard metal.

4. The insert tool according to claim 1, wherein the cutting body is machined by way of a grinding method in such a way that the cutting body has at least two ground faces.

5. The insert tool according to claim 4, wherein at least one of the at least two ground faces takes the form of a flank.

6. The insert tool according to claim 4, wherein the cutting body has four ground faces or seven ground faces.

7. A system, comprising:
a first insertion tool according to claim 1; and
a second insertion tool according to claim 1,
wherein the base modules of the first insertion tool and the second insertion tool are designed to be substantially identical, and
wherein the base modules of the first insertion tool and the second insertion tool are connected to different insertion ends in an integrally bonded manner and/or the cutting bodies are machined by manners of different grinding methods.

8. The system according to claim 7, wherein the first insertion tool and the second insertion tool have different surface identifiers.

9. A method for producing an insert tool, comprising:
in a first method stage, providing a base module, which has a basic body, which in particular comprises a conveying helix, and a cutting body; and
in a second method stage, by means of in each case at least one method step, adapting the base module to a handheld power tool, to a workpiece to be machined, and with a surface identifier.

10. The method for adapting a second method stage according to claim 9, with a dataset, which information for adapting a base module to a handheld power tool, to a workpiece to be machined, and of the surface identifier, is provided by a computing unit or is provided to a computing unit.

11. The insert tool of claim 1, wherein the insert tool is a drilling tool.

12. The insert tool of claim 1, wherein the cutting body has at least two rake faces.

13. The insert tool of claim 1, wherein the insertion end is hardened.

14. The insert tool of claim 1, wherein the base module is connected at the second end of the first portion to the insertion end by way of a friction welding method.

15. The insert tool of claim 3, wherein the cutting body completely comprises a hard metal.

16. The insert tool according to claim 4, wherein the at least two ground faces take the form of rake faces.
